(19) United States
(12) Patent Application Publication
(10) Pub. No.: US 2003/0131446 A1
(43) Pub. Date: Jul. 17, 2003

(54) Adjustable hinge

(76) Inventor: C. Scott Bender, New Brighton, PA (US)

Correspondence Address: BUCHANAN INGERSOLL, P.C., ONE OXFORD CENTRE, 301 GRANT STREET, 20TH FLOOR, PITTSBURGH, PA, 15219, US

(21) Appl. No.: 10/047,170

(22) Filed: Jan. 15, 2002

(51) Int. Cl. E05D 11/06

(52) U.S. Cl. 16/375

(57) ABSTRACT

A door hinge having a first hinge member is attachable to a door frame, and has a cup-like recess in which a portion of a second hinge member, attachable to a door associated with the door frame, is received when the first and second hinge members are in a closed position. The second hinge member can include an arm hinged to the second hinge member at a location inside the cup-like recess. When the door is opened, the arm rotates about the hinge, lifting the second hinge member up out of the recess away from the first hinge member. Maximum travel of the second hinge member is limited by impingement of the arm against an adjacent side of the cup-like recess. A range of adjustment of travel can be provided by an adjustment member cooperating between the arm and the adjacent side of the cup-like recess. The adjustment member can be a set screw disposed in a threaded opening through the arm, allowing the set screw to contact the adjacent side of the cup-like recess. The set screw can be advanced through the arm, by varying amounts, to impinge upon the adjacent wall of the cup-like recess before the arm would otherwise impinge, thus providing a variably adjustable range of travel.

### FIELD OF THE INVENTION

1. Field of the Invention

This invention relates generally to a hinge for a door, and more particularly, to a door hinge which has an adjustment feature enabling convenient control over the maximum degree to which the hinge, and thus the door, can be opened.

2. Background of the Invention

Door hinges, such as for cabinets, are well known. In general, a door hinge has two primary components: a first member “hinged” to a second member. One of the members attaches to the edge of a door frame adjacent the door, and other attaches to the edge of the door adjacent the door frame. The “hinged” connection permits the two members to rotate, about the axis of the hinge, relative to each other, thus permitting the door to rotate, i.e., open, away from the door frame. In the closed position, the two hinged members are generally adjacent each other, with the door typically abutting or aligned with the door frame.

In the open position, a simple hinge will generally permit the door to rotate about 180 degrees, absent any obstruction to the door or limiting elements of the hinge. However, conventional “cabinet” door hinges, such as, for example, kitchen and bathroom cabinets, and the like, are known to include elements which limit the travel of the one hinge member with respect to the other. This feature can be provided where the owner desires some type of built-in limitation on how far the cabinet door can open. Additionally, this feature is commonly associated with another feature—spring loaded tension on the hinge members which tends to pull the cabinet door closed when the cabinet door is closed a certain degree from the fully opened position. This feature can also ensure that the cabinet door is generally held in the closed position until enough force is exerted on the cabinet door to overcome the initial tension.

There are well known types of cabinet door hinges wherein the member attached to the cabinet frame is not simply a flat member, as a typical door hinge tends to be, but instead has a cup-like recessed area in which a portion of the cooperating hinge member, i.e., the member which is attached to the cabinet door, is received when the cabinet door is closed. In this type of hinge, the hinge member attached to the cabinet door has an arm which is hinged inside the cup-like recess. When the cabinet door is opened, the arm rotates about the hinge around and out of the recess. A spring can also be included to provide tension between the arm and the cup-like recess for the purposes described above. However, the travel of the cabinet door is typically limited in these types of hinges by the length and/or shape of the arm. This is because, at some point, the arm will impinge on the side of the cup-like recess, thus preventing further rotation about the hinged connection.

The limitation on the degree to which the cabinet door opens can be desirable, as explained above, but the degree to which the cabinet door can open is not adjustable with these known types of hinges. The degree to which the cabinet door can open is dependent on fixed, non-adjustable, elements of the hinge, for example, the length and/or configuration of the arm, the depth of the cup-like recess, and the location of the hinged connection within the cup-like recess. Consequently, different hinges would have to be purchased/designed in order for the owner to customize the degree to which the cabinet door will open. This can also require removal and re-installation of hinges if the initially installed hinges do not provide the desired degree of cabinet door travel, thus making customization inconvenient and more costly. Therefore, in order to permit owners to personally, and conveniently, customize the degree to which the cabinet door will open, it would be desirable to have such a cabinet door hinge which includes a feature that permits adjustment of the degree to which the cabinet door can open after the hinge is already installed on the cabinet.

### SUMMARY OF THE INVENTION

A hinge according to the invention can include a first hinge member attachable to a door frame and a second hinge member attachable to a door. The first hinge member has a cup-like recess in which a portion of a second hinge member is received when the first and second hinge members are in a closed position. The second hinge member is attachable to a door associated with the frame. The second hinge member has an arm which is hinged inside the cup-like recess. When the cabinet door is opened, the arm rotates about the hinge around and out of the recess. In some embodiments, a spring can also be included to provide tension between the arm and the cup-like recess for the purposes explained previously.

Overall, the range of travel of the cabinet door is limited by such design factors as the length and/or shape of the arm, the positioning of the hinged attachment within the recess, and the dimensions/configuration of the recess. The range of travel is limited because, at some point, in this case the maximum possible degree of travel, the arm itself will impinge on the side of the cup-like recess, thus preventing further rotation about the hinged connection. However, adjustment within a range of travel, such as between fully open position and a nearly fully open position, can be provided for by a door travel adjustment member which cooperates between the arm and an adjacent side of the cup-like recess.

In a presently preferred embodiment, the adjustment member can be a set screw disposed in a threaded opening provided through the arm, allowing the set screw to contact the adjacent side of the cup-like recess. The set screw can be positioned to extend through the arm and impinge upon the adjacent wall of the cup-like recess before the arm itself would otherwise impinge. The set screw can be easily accessible, for example, by an allen wrench, screwdriver, or other tool, after the hinge is installed. The maximum overall degree of travel would be provided for when the set screw was withdrawn from the threaded opening to a position where the arm itself, instead of the set screw, was permitted to impinge on the adjacent wall of the cup-like recess. This would correspond to a fully open position of the door. However, a range of lesser degrees of travel can be conveniently provided to customize the degree of travel by simply advancing the set screw through the threaded opening in the arm so that the set screw impinges on the adjacent side of the cup-like recess. The further the set screw is advanced through the threaded opening in the arm, the sooner the set screw impinges on the adjacent wall of the cup-like recess, and thus the lesser the degree of travel of the door. Therefore, the degree of travel of the door can be easily customized after the hinge is installed simply by adjusting the set screw.

Other details, objects, and advantages of the invention will become apparent from the following detailed description and the accompanying drawing figures of certain presently preferred embodiments thereof.

### BRIEF DESCRIPTION OF THE DRAWING FIGURES

A more complete understanding of the invention can be obtained by considering the following detailed description in conjunction with the accompanying drawings, in which:

FIG. 1 is a side view of a presently preferred embodiment of the invention in a closed position.

FIG. 2 is a side view of the embodiment in FIG. 1, except shown in an open position.

FIG. 3 is a front perspective view of the embodiment in FIG. 1, except shown in an open position as in FIG. 2.

FIG. 4 is a side view similar to FIG. 2, except of the opposite side and shown partially in section.

### DETAILED DESCRIPTION OF THE PREFERRED EMBODIMENTS

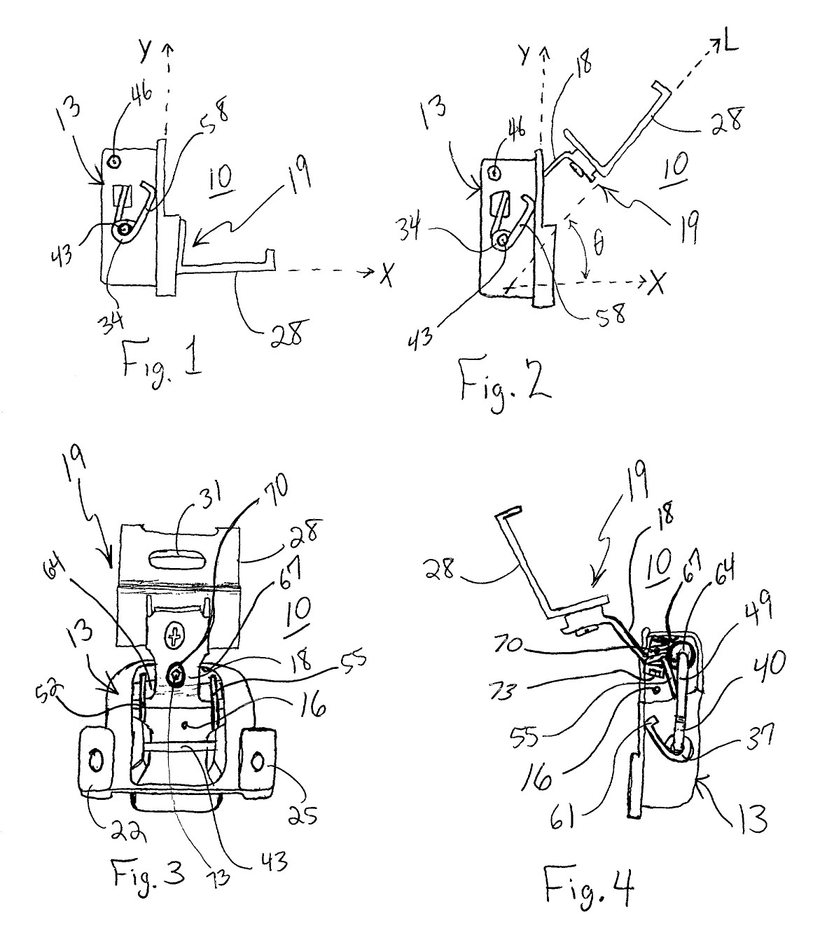

Referring now to the drawing figures, wherein like reference numbers refer to like elements in each of the drawings, in FIG. 1 there is illustrated a presently preferred embodiment of a door hinge 10. The door hinge 10 can include a first hinge member 13 with a cup-like recess 16. An arm portion 18 of a second hinge member 19 is received in the cup-like recess 16 when the first 13 and second 19 hinge members are in a closed position. The first hinge member 13 is attachable to a door frame (not shown) and the second hinge member 19 is attachable to a door (also not shown) associated with the door frame.

The door hinge 10 is of a well known type wherein the first 13 and second 19 hinge members are hinged at a common axis along an adjacent side. The hinge members 13, 19 rotate relative to the each other about the axis of the hinge. In this type of hinge member 10, generally the only limitation on the rotation of the second hinge member 19 relative to the first hinge member 13 is impingement of the door, to which the second hinge member is attached, either against the door frame to which the first hinge member 13 is attached or against an obstruction on the other side of the door. This is the case unless there is some other additional element of the door hinge 10 which otherwise limits movement of the second hinge member 19 with respect to the first hinge member 13.

As is the purpose of the hinge 10, the hinged attachment of the first 13 and second 19 hinge members permits the door to open and close against the door frame. The hinge 10 is shown in the closed position in FIG. 1, and is movable to an open position, as shown in FIG. 2. In each of these figures, the “X” and “Y” axes are labeled for purposes of illustrating the degree of travel Ø of the second hinge member 19 with respect to the first hinge member 13 between the open and closed positions.

The inner workings of a presently preferred embodiment of the hinge are better illustrated in FIGS. 3 and 4. As can be seen, the first hinge member 13 has attachment portions 22, 25 on either side thereof for connecting the second hinge member 19, such as by screws, to a door frame. Similarly, the second hinge member 19 includes a generally L-shaped member 28 having a slot 31 therein for attaching the second hinge member 19 to a door associated with the door frame. A pair of spring tensioning members, 34, 37, one on either side of the first hinge member 13, can be provided for tensioning the movement of the second hinge member 19 with respect to the first hinge member 13. When in a closed position, the spring tensioning members 34, 37 bias the second hinge member 19 against the first hinge member 13, and thus bias the door closed so that it will remain in the closed position unless enough force is exerted on the door to overcome the spring tension. The arrangement of the spring tensioning members 34, 37 can also be configured such that when the door is in an open position, the door will remain open until sufficient force is exerted on the door to close the door past a certain point, at which the spring tensioning again pulls the second hinge member 19 closed against the first hinge member 13.

As shown in the drawings, a C-shaped pin member 40, having essentially first and second straight leg portions 43, 46 at either end thereof, joined by a curve portion 49. The leg 46 forms the hinge pin about which the arm 18 rotates. The first leg 43 forms the pin which extends through a central portion of the cup-like recess and, on the ends thereof, are supported the coils of the spring tensioning members 34, 37. As shown, the ends 52, 55 of each spring tensioning member 34, 37 are positioned inside the cup-like recess 16, biased against a lower portion of the arm 18. The opposite ends 58, 61 of each spring tensioning member 34, 37 are biased against the underside of the first hinge member 13. The lower end of the arm 18 of the second hinge member 19 can include a hollow tubular member 64 through which is disposed the hinge pin, i.e., the second leg portion 46 of the C-shaped pin member 40, about which the arm rotates in a manner well-known in the art. The rotatable attachment of the arm 18 to the hinge pin 46, and the configuration of the spring tensioning members 34, 37 in association with the arm 18, are well-known in the art and the description thus far simply describes one type of well-known hinge construction.

However, according to a preferred embodiment of the invention shown in FIG. 4, an adjustment member, for example, a set screw 70, can cooperate between the arm 18 and an adjacent surface 67 of the cup-like recess 16 for limiting the travel of the arm 18 toward the adjacent surface 67. Of course, the maximum travel would occur where the arm 18 is permitted to impinge on the adjacent surface 67. However, the maximum travel can be variably limited by the set screw 70 which limits the travel of the arm 18 toward the adjacent surface 67 of the cup-like recess 16. The set screw 70 can be advanced through the hole 73, which can be threaded, in the arm portion 18 into abutment with the adjacent side 67 of the cup-like recess 16. The set screw 70, when advanced through the hole 73 by a selectively variable amount, will impinge upon the adjacent side 67 of the cup-like recess 16, prior to impingement of the arm 18, when the second hinge member 19 is rotated away from the first hinge member 13. As can be understood, a maximum degree of travel of the arm 18 will occur when the set screw 70 is withdrawn from the hole 73 in order to allow the arm 18 to impinge upon the adjacent side 67 of the cup-like recess 16. In order to adjust the degree of travel, the set screw 70 may be advanced any amount desired through the threaded hole 73 in the arm 18 in order to impinge upon the adjacent side 67 of the cup-like recess 16 prior to the arm 18. The adjustment can be easily accessible after the hinge 10 is installed, simply by opening the door, thus separating the first hinge member 13 from the second hinge member 19 and exposing the arm 18 and the set screw 70. A tool, such as an allen wrench, screwdriver, or like tool, can be used to advance or withdraw the set screw 70 in the hole 73 depending on the desired degree of maximum door travel.

In this manner, a hinge 10 according to the invention can be selected having a desired maximum door travel, depending on the size of the hinge 10, and the length and configuration of the arm 18 and the cup-like recess 16. Then, once installed, the actual maximum degree of travel of the door can be customized simply by adjusting the set screw 70.

Although certain embodiments of the invention have been described in detail, it will be appreciated by those skilled in the art that various modification to those details could be developed in light of the overall teaching of the disclosure. In particular, many other ways of adjustably limiting the movement of the first hinge member 13 relative to the second hinge member 19 can be devised by those of ordinary skill in the art in view of the teaching provided herein. Accordingly, the particular embodiments disclosed herein, for example using a set screw 70, are intended to be illustrative only and not limiting to the overall scope of the invention, which should be awarded the full breadth of the following claims and any and all embodiments thereof.

What is claimed is:

1. An adjustable door hinge comprising:
a. first and second hinge members adapted for attachment to one of a door frame and a door associated with said door frame;
b. said first hinge member having a cup-like recess;
c. said second hinge member having an arm portion rotatably attached within and adjacent to a side of said cup-like recess such that said second hinge member is movable relative to said first hinge member via said arm portion;
d. said second hinge member movable between a closed position wherein said second hinge member is generally adjacent said first hinge member, and an open position wherein said second hinge member is rotated away from said first hinge member;
e. said second hinge member having a maximum range of travel away from said first hinge member defined by said arm portion impinging said adjacent side of said cup-like recess; and
f. an adjustment member cooperating between said arm and said adjacent side of said cup-like recess, said adjustment member limiting travel of said second hinge member by limiting movement of said arm towards said adjacent side of said cup-like recess.

2. The adjustable door hinge of claim 1 further comprising:
a. said arm having an opening therethrough; and
b. said adjustment member disposed in said opening, said adjustment member movable in said opening to extend through said opening and impinge said adjacent side of said cup-like recess prior to said arm impinging thereon.

3. The adjustable door hinge of claim 2 further comprising:
a. said opening through said arm being a threaded opening;
b. said adjustment member being a screw advanceable through said threaded opening to extend a selectable distance beyond said arm to impinge said adjacent side of said cup-like recess prior to said arm impinging thereon.

4. An adjustable hinge comprising:
a. first and second hinge members having adjacent portions, said first and second hinge members rotatably joined about an axis through said adjacent portions; and
b. an adjustment member cooperating between said adjacent portions, said adjustment member selectively limiting rotation about said axis between said first and second hinge members.

5. The adjustable hinge of claim 4 further comprising:
a. said first hinge member having a cup-like recess;
b. said second hinge member having an arm portion rotatably attached within and adjacent to a side of said cup-like recess such that said second hinge member is rotatable about said axis via said arm portion; and
c. said adjustment member cooperating between said arm and said adjacent side of said cup-like recess to selectively limit said rotation by limiting movement of said arm toward said adjacent side of said cup-like recess.

6. The adjustable hinge of claim 5 further comprising:
a. said arm having an opening therethrough; and
b. said adjustment member disposed in said opening, said adjustment member movable in said opening to extend through said opening and impinge on said adjacent side of said cup-like recess prior to said arm impinging thereon to selectively limit movement of said arm toward said adjacent side.

7. The adjustable hinge of claim 6 further comprising:
a. said opening through said arm being a threaded opening;
b. said adjustment member being a screw advanceable through said threaded opening to extend a selectable distance beyond said arm to impinge said adjacent side prior to said arm impinging thereon.
